(19) United States
(12) Patent Application Publication
(10) Pub. No.: US 2007/0284905 A1
(43) Pub. Date: Dec. 13, 2007

(54) Vehicle Seat with Swing-Out Lower Seat Portion

(75) Inventor: Jack L. Bailey, Center Line, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., Detroit, MI (US)

(21) Appl. No.: 11/423,183

(22) Filed: Jun. 9, 2006

(51) Int. Cl. B60N 2/04

(52) U.S. Cl. 296/65.07

(57) ABSTRACT

A vehicle seat is provided with a swing-out lower seat portion that allows ease of entering and exiting a vehicle. The lower seat portion pivots laterally independently of the seat back portion. The pivot axis is inside of the outer perimeter of the lower seat portion, preferably toward the outboard side of the seat. This position of the pivot axis allows the lower seat portion to pivot through the vehicle doorway without interfering with a vehicle console running fore and aft adjacent the seat opposite the doorway. The amount of pivoting is preferably at least 60 degrees and may be up to 90 degrees depending on the vehicle parameters, such as the location of B-pillar.

### TECHNICAL FIELD

The invention relates to a vehicle seat with a pivotable lower seat portion.

### BACKGROUND OF THE INVENTION

Typically, to enter a vehicle and be seated, a person must navigate through a vehicle door opening and be seated on a forward-facing seat. This may involve traversing a wide rocker panel and seal plate and sliding over the outboard lower seat cushion bolster. This entry motion requires some twisting, bending and sideways shifting. To exit the vehicle, the reverse of the entry motion is required. Certain persons may find entering and exiting a vehicle seat challenging.

Vehicle seats that swivel in and out through the vehicle doorway to aid entry and exit are known. In all such swivel seats, the back portion and the lower seat portion swivel together as a unit. The swiveling back portion may interfere with a center console in some vehicle designs, limiting design options. The swiveling back portion may limit the pivot range of the seat.

### SUMMARY OF THE INVENTION

A vehicle seat is provided with a swing-out lower seat portion that allows ease of entering and exiting a vehicle. The lower seat portion pivots laterally independently of the seat back portion. The pivot axis is inside the outer perimeter of the lower seat portion, preferably toward the outboard side of the seat. This position of the pivot axis allows the lower seat portion to pivot through the vehicle doorway (i.e., over the rocker panel and seal plate), preferably pivoting at least 60 degrees from an in-use position to a loading/unloading position, without interfering with a vehicle console running fore and aft adjacent the seat opposite the doorway. The amount of pivoting may be up to 90 degrees depending on the vehicle parameters, such as the location of B-pillar.

In one embodiment of a vehicle seat within the scope of the invention, the lower seat portion has an upper mount frame. The seat includes a lower mount frame that is nonpivotably attached to a seat track assembly. The upper mount frame pivots with the lower seat portion relative to the lower mount frame. A friction-reducing member, such as a low coefficient of friction plastic sheet, may be attached to either of the upper and lower mount frames between the mount frames to decrease friction during pivoting.

A bearing is positioned between the upper and lower mount frames to allow the relative pivoting. The bearing may be a flat plate bearing sandwiched between the upper and lower mount frames with a center support member running through the bearing concentric with the pivot axis. Bolts run through the center support member and through openings in the lower mount frame to secure the center support member to the lower mount frame. In an alternative embodiment, the bearing is a tapered roller bearing with an inner race circumscribing a pivot shaft rigidly secured to the upper mount frame and an outer race secured to the lower mount frame.

The upper and lower mount frames are releasably lockable to one another. A latching mechanism mounted on one of the mount frames latches to a pin on the other mount frame when the lower seat portion is forward facing (i.e., in an in-use position) such that the mount frames are latched and not pivotable relative to one another. A latch release mechanism is manually or automatically operated to cause the latching mechanism to release the pin and allow the upper mount frame to pivot laterally. The seat may be manually pivoted. Other embodiments pivot automatically. If the seat is manually pivotable, a button or lever operates a solenoid that is operatively connected to the latching mechanism to latch or unlatch the pin. If the seat operates automatically, a controller sends a control signal to the solenoid to latch or unlatch the latching mechanism. The controller generates the control signal based on a sensor signal received from a sensor that senses whether the door is opened or closed. To ensure that the seat is secured in the forward, in-use position when the vehicle is being driven, a sensor may be employed with either the automatic or the manual seat to prevent the latch release mechanism from releasing the latching mechanism when the sensor senses that the door is closed. Additionally, with an automatic seat, an override button, also referred to herein as a mode selection button, may be provided to allow an occupant to override the automatic pivoting of the lower seat portion; for instance, if the occupant wishes to open the door but not exit the vehicle, he may wish to keep the seat in the in-use position. Pressing the override button will prevent the controller from generating a control signal in response to the sensor signal indicating the door is open, thereby preventing automatic pivoting. The override button may also be twistable to set rotational speed of the seat.

The pivoting motion of the lower seat portion may be accomplished manually by an occupant physically rotating the lower seat portion. A torsion spring may be concentric with the pivot axis and operatively connected to the upper mount frame to assist the pivoting motion. Alternatively, in an automatic system, a drive motor may be operatively connected to the pivot shaft. A shaft of the drive motor may be configured as a worm gear that intermeshes with a gear that is concentric with the pivot shaft and internally splined to mesh with external splines on the pivot shaft. The shaft and the gear concentric with the pivot shaft enable the motor to turn the pivot shaft. The motor may be controlled automatically by a controller that responds to the sensor to pivot the seat when the door is opened. Alternatively, a push button may be employed to allow an occupant to control operation of the motor.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic illustration in fragmentary plan view of a vehicle with a vehicle seat having the lower seat portion in an in-use position;

FIG. 2 is a schematic illustration in plan view of the vehicle seat of FIG. 1 with a lower seat portion shown in a pivoted position;

FIG. 3 is a fragmentary schematic cross-sectional illustration of the vehicle seat of FIGS. 1 and 2 with an upper mount frame included in the lower seat portion and a lower mount frame secured to a seat track assembly, with a pivot shaft and bearing assembly connected between the mount frames, and with an optional torsion spring;

FIG. 4 is a schematic illustration in plan view of the lower mount frame of FIG. 3, with an alternative bearing assembly;

FIG. 5 is a schematic illustration in plan view of the upper mount frame of FIG. 3 with a swivel center support member used in lieu of a pivot shaft with the alternative bearing assembly of FIG. 4;

FIG. 6 is a schematic side view illustration of the swivel center support member used with the alternative bearing assembly of FIG. 5; and

FIG. 7 is a schematic illustration in bottom view of a modified pivot shaft with a gear that is operatively connected with an optional drive motor for automatically pivoting the lower seat portion of FIG. 1.

### DESCRIPTION OF THE PREFERRED EMBODIMENTS

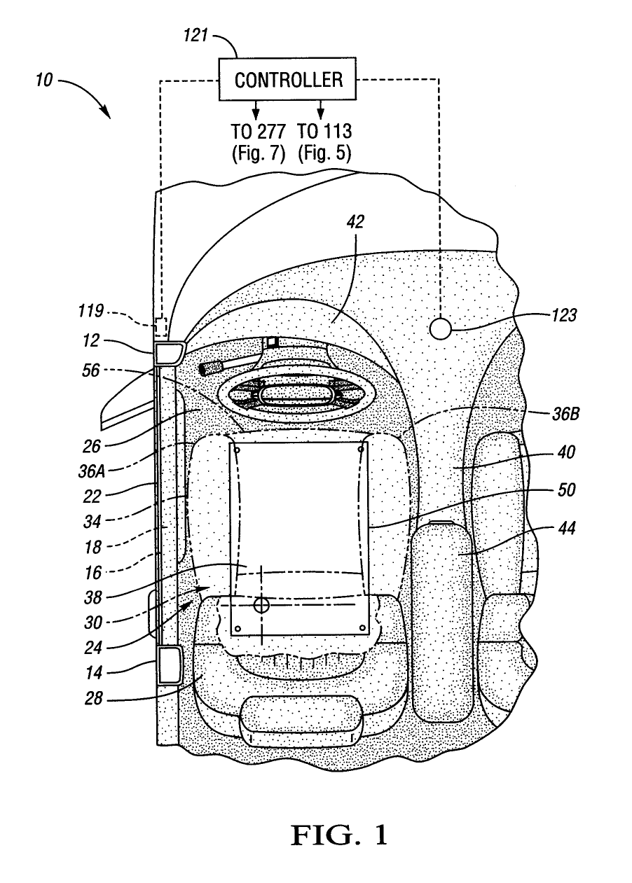

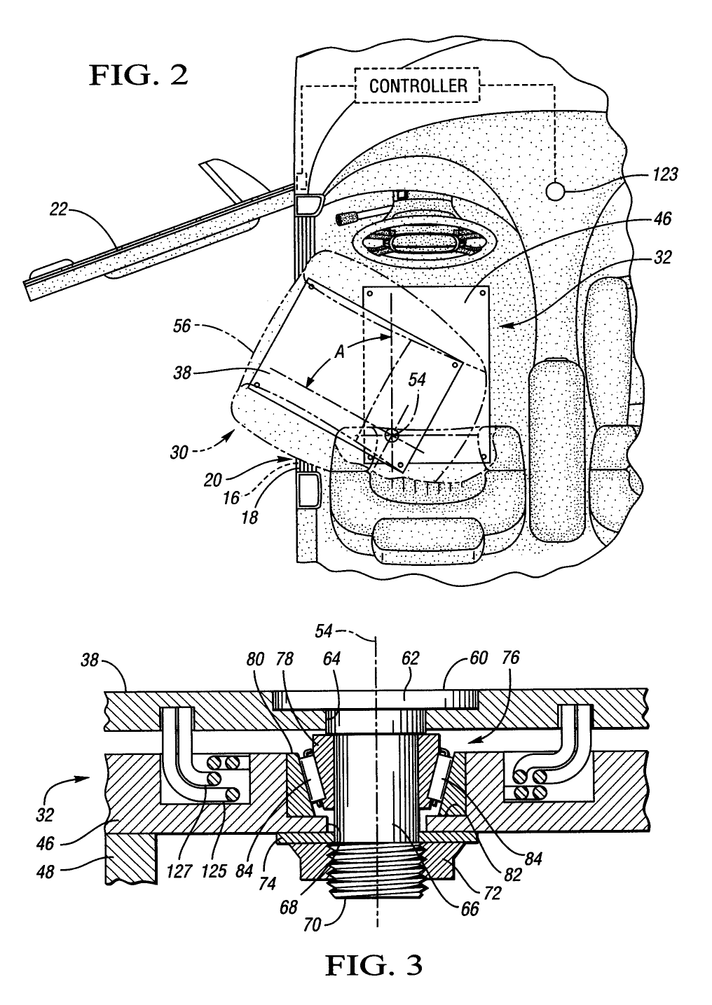

Referring to the drawings, wherein like reference numbers refer to like components, FIG. 1 shows a portion of a vehicle 10. The vehicle 10 has a vehicle frame composed in part of an A-pillar 12, a B-pillar 14 and a rocker panel 16. The rocker panel 16 is covered by a seal plate 18 (see FIG. 2), as is known in the art and are both covered by a door 22 in a closed position. The A-pillar 12, B-pillar 14, rocker panel 16, and a roof rail (not shown, but spanning between the A-pillar and the B-pillar as is known) define a door opening 20 (see FIG. 2). The door 22 is hinged about the A-pillar and locks to the B-pillar, as is known in the art and is pivotable to open (see FIG. 2) and close (see FIG. 1) the door opening 20.

A vehicle seat 24 is secured laterally inboard of the door opening 20 to the vehicle floor 26. Although the vehicle seat 24 is a driver's seat, the invention applies to any vehicle seat located adjacent a doorway. The seat may be a bucket seat or a split bench seat. The vehicle seat 24 includes a seat back portion 28, a lower seat portion 30 and a base portion 32 (shown in FIGS. 2 and 3). The lower seat portion 30 includes a cushion 34 (shown in phantom) with side bolster portions 36A, 36B running fore and aft on either side. The lower seat portion 30 also includes an upper mount frame 38 covered by the cushion 34.

A center console 40 runs fore and aft along the floor 26 adjacent the seat 24, extending from the vehicle dash 42 all the way rearward of the lower seat portion 30. The center console 40 includes an optional storage compartment 44.

The base portion 32 is nonpivotably secured to the floor 26. The base portion 32 has a lower mount frame 46 and a seat track assembly 48. The base portion 32 is shiftable fore and aft along the seat track assembly 48 which is rigidly secured to the floor 26. Seat track assemblies are well known in the art. Only an outboard portion of the seat track assembly 48 is shown in FIG. 3; a symmetrical inboard portion of the seat track assembly 48 runs fore and aft under the inboard edge 50 (visible in FIG. 1 but not if FIG. 3) of the lower mount frame 46.

The upper mount frame 38 may be in addition to a separate lower seat cushion structural frame, or may be serve as the structural frame of the lower seat cushion 34. Similarly, the lower mount frame 46 may be in addition to a structural frame for the base portion 32 or may serve as a structural frame for the base portion 32. Preferably, the upper mount frame 38 and the lower mount frame 46 serve as the respective structural frames of the lower seat cushion 34 and the base portion 32 and are sheet metal stampings, a plastic composite material or a lightweight aluminum alloy material to minimize weight. The upper mount frame 38 and the lower mount frame 46 are illustrated as relatively flat plate-like structures in FIGS. 1-5 and 7. However, within the scope of the invention, the upper mount frame 38 and the lower mount frame 46 may have a variety of stamped or formed shapes with the upper mount frame 38 having the ability to rotate with respect to the lower mount frame 46.

The lower seat portion 30 is laterally pivotable about a pivot axis 54 so that it swings out over the rocker panel 16 and seal plate 18 through door opening 20, as shown in FIG. 2. The lower seat portion 30 pivots from a first position, shown in FIG. 1, in which a forward edge 56 of cushion 34 moves from a position substantially transverse of the seal plate 18 and door opening 20 to a second position, shown in FIG. 2, in which the forward edge 56 is substantially outboard of the seal plate 18 and door opening 20. The first position is an in-use position, i.e., a suitable position for when the vehicle 10 is in motion. The second position is a loading/unloading position that enables an occupant to enter and exit the seat 24 without having to straddle the seal plate 18 and door opening 20 and without having to lift up over the side bolster portion 36A.

As is evident from FIGS. 1 and 2, the lower seat portion 30 pivots between the first and second positions without interfering with or contacting the console 40. That is, the console 40 remains stationary and need not be modified in any way when the lower seat portion 30 is pivoted. Because the seat back portion 28 does not pivot, i.e., because the lower seat portion 30 pivots independently of the seat back portion 28, required clearance between the seat 24 and the console 40 is minimized. If the seat back portion 28 swiveled, it would swing into a rearward portion of the console 40, therefore only allowing a center console that extends far less rearward (i.e., no more rearward than the typical location of the rear of a shift lever prindle plate). Placement of the pivot axis 54 generally rearward and outboard inside of an outer perimeter of the lower seat portion (the outer perimeter being defined by the outer perimeter of the cushion 34 shown in phantom if FIG. 1) maximizes the degree to which the lower seat portion 30 extends through the door opening 20. Preferably, the pivot axis 54 is only inboard of the outer perimeter a distance that is five percent of the overall width of the lower seat portion. This is desirable as the further outboard the axis is, the further the cushion 34 will rotate over the seal plate 18. By locating the pivot axis 54 substantially outboard but inside of the outer perimeter of the lower seat portion 30, interference of the lower seat portion 30 with the console 40 is minimized, permitting a greater angle of swing. When the pivot axis 54 is positioned according to these parameters, the lower seat portion 30 can rotate at least 60 degrees between the in-use position (FIG. 1) and the loading/unloading position (FIG. 2), as indicated by angle A in FIG. 2. Angle A is formed between the location of an axis perpendicular to the pivot axis 54 the direction the lower seat portion 30 is facing in first and second positions correspondingly with the in-use and the loading/unloading position.

Referring to FIG. 3, the components of the seat 24 that allow the pivoting motion described above will now be explained in detail. A shoulder portion 60 of a one-piece pivot shaft 62 is press-fit or welded to the upper mount frame 38. The pivot shat 62 extends through a stepped opening 64 therethrough. An arm portion 66 extends through an opening 68 in the lower mount frame 46 and has a threaded portion 70 at an outer circumference about which an internally threaded nut 72 is tightened. A spacer 74 is placed between the nut 72 and the lower mount frame 46 to aid relative rotational movement of the shaft 62 and the nut 72 relative to the lower mount frame 46 when the pivot shaft 62 pivots with the upper mount frame 38. The spacer 74 is preferably made of a fluoropolymer resin (such as that marketed as TEFLON, a registered trademark of E. I. Du Pont de Nemours and Company, Wilmington, Del.), silicon, or another low friction material.

A bearing assembly 76 is placed between the upper mount frame 38 and lower mount frame 46 to aid pivoting of the upper mount frame 38. The bearing assembly 76 includes an annular inner race 78 secured about the arm portion 66 of the pivot shaft 62. An annular outer race 80 is press fit or otherwise secured to the lower mount frame 46 within a recess 82. Tapered rollers 84 are spaced circumferentially between the inner and outer race 78, 80. The tapered roller bearing type bearing assembly 76 occupies a minimal radial packaging space about the pivot axis 54, thus allowing the pivot axis 54 to be placed as far outboard as possible within the outer perimeter of the lower seat portion 30, as discussed above.

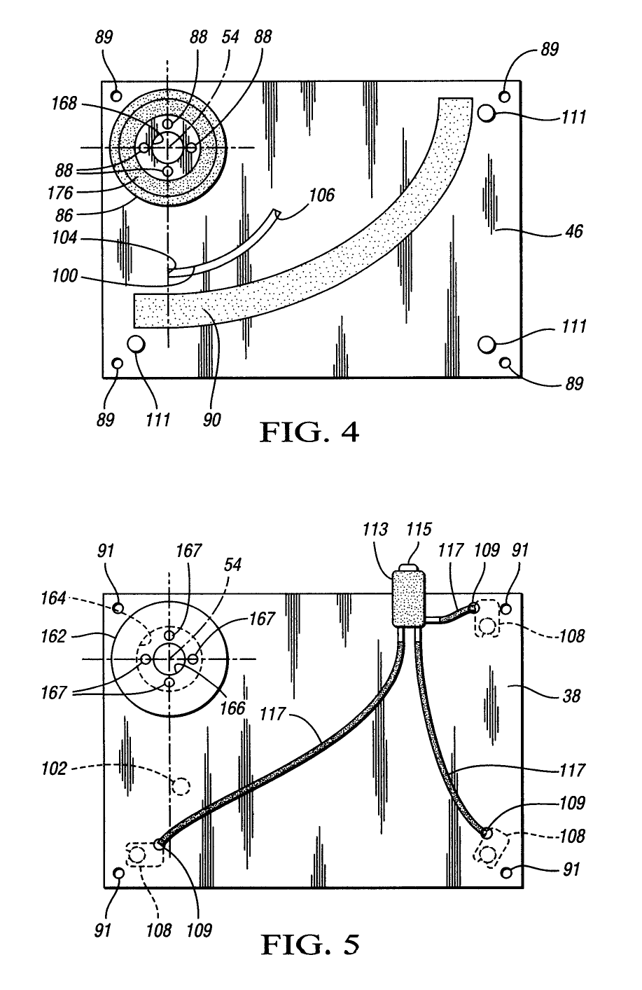

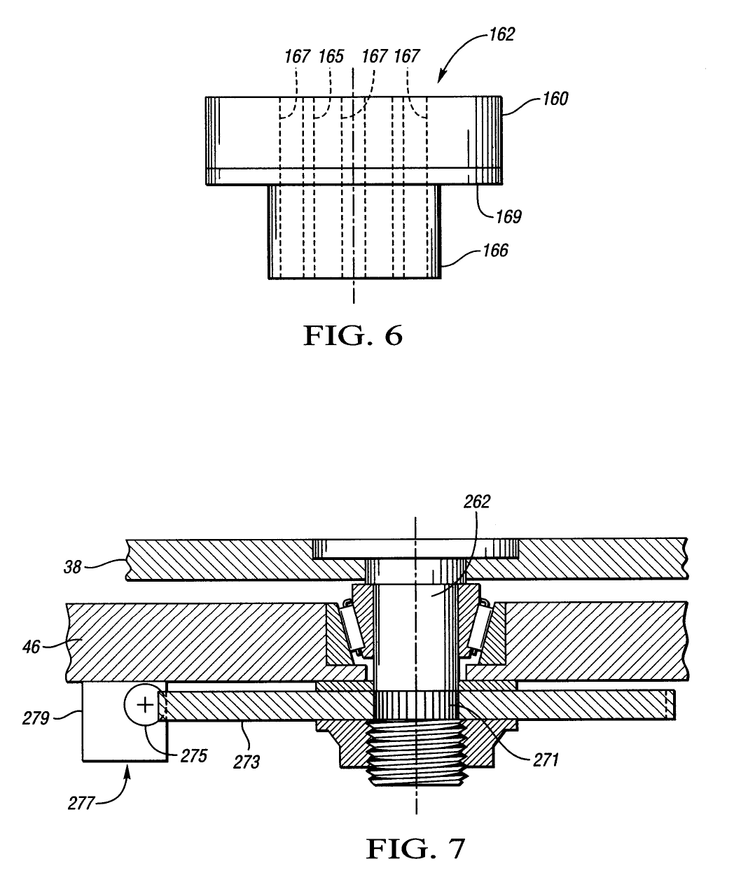

Referring to FIGS. 4 and 5, the upper and lower mount frames 38, 46 are shown in greater detail. A different bearing assembly 176 is employed than that shown and described with respect to FIG. 3. The bearing assembly 176 is a roller bearing-type including upper and lower races (only upper race visible in FIG. 4) with ball bearings placed therebetween to allow relative rotation of the races. A pinch flange 86 is welded or screwed around the races to prevent dirt and debris from entering. The lower mount frame 46 has an optional opening 168 concentric with the pivot axis 54. Fastener openings 88 are spaced about the opening 168. The upper mount frame 38 of FIG. 5 has an opening 164 concentric with the pivot axis 54. A swivel center support 162, best viewed in FIG. 6, has a shoulder portion 160 and an arm portion 166. A center bore 165 extends through the swivel center support 162. Fastener openings 167 extend through the swivel center support 162 and are spaced circumferentially around the center bore 165 to align with the fastener openings 88 when the upper mount frame 38 is aligned with the lower mount frame 46 as shown in FIG. 1. Fasteners (not shown) such as threaded bolts are placed through the fastener openings 167 and through mating openings 88, with the bearing assembly 176 sandwiched therebetween. An annular slip washer or spacer 169 is placed beneath the shoulder portion 160 of the swivel center support 162. A wiring harness (not shown) may extend through the aligned openings (center bore 165 and opening 168) to access a motor, as discussed with respect to FIG. 7, or to access other electrical components.

Apart from the alternative bearing assembly 176 and the swivel center support 162 used in lieu of the bearing assembly 76 and pivot shaft 62 of FIG. 3, other aspects of the upper and lower mount frames 38, 46 are the same as those used in FIGS. 1 through 3 with the tapered roller bearing-type bearing assembly 76 and pivot shaft 62. Referring to FIG. 4, mounting holes 89 are provided in the lower mount frame 46 to attach the lower mount frame 46 to the seat track assembly 48 of FIG. 3 with bolts (not shown) or other suitable fasteners. Similarly, referring to FIG. 5, mounting holes 91 are provided through the upper mount frame 38 to attach the upper mount frame 38 to the cushion 34 with bolts (not shown) or other suitable fasteners. A friction-reducing member 90 is adhered or otherwise secured to the lower mount frame 46 and extends upward therefrom sufficiently such that it will contact a lower surface of the upper mount frame 38 when the mount frames are assembled as in FIGS. 1 through 3. The friction-reducing member 90 has a lower coefficient of friction than the mount frames 38, 46 so that when the upper mount frame 38 pivots, frictional resistance to such lateral pivoting is decreased. A friction-reducing member may alternatively be placed on a lower surface of the upper mount frame extending downward to contact the lower mount frame 46. Still alternatively, friction-reducing members may be placed on both the upper and lower mount frames 38, 46 such that the friction-reducing member on the upper mount frame 38 contacts the friction-reducing member on the lower mount frame 46 during pivoting.

Referring again to FIG. 4, the lower mount frame 46 has a curved guide slot 100 formed or cut therein. Referring to FIG. 5, an extension guide pin 102 such as an elongated pin extends downward from the lower surface of the upper mount frame 38 such that it extends through the guide slot 100. The extension 102 is positioned on the upper mount frame 38 such that it rests in the guide slot 100 at a first end 104 of the guide slot 100 when the lower seat portion 30 is in the in-use position of FIG. 1 and translates along the guide slot 100 until it reaches the second end 106 of the slot 100 as the upper mount frame 38 pivots with the lower seat portion 30 to the second position of FIG. 2. Thus, the second end 106 of the guide slot 100 interferes with the extension 102 to limit pivoting of the lower seat portion 30.

Referring to FIG. 1, in order to ensure that the lower seat portion 30 remains securely in the in-use position when desired, such as during driving of the vehicle 10, the upper mount frame 38 and the lower mount frame 46 are releasably lockable to one another. In FIG. 5, latching mechanisms 108 are secured to a lower surface of the upper mount frame 38. The latching mechanisms 108 automatically latch about pins 111 that extend upward from an upper surface of the lower mount frame 46 when placed in contact with the pins 111. The latching mechanisms 108 may be similar to a typical vehicle door latch, with a latch that is urged to surround a striker when the striker is moved into contact with the latch. When it is desired to pivot the lower seat portion 30, to the second position of FIG. 2, a latch release mechanism 113 is operated to pull the latches of the latching mechanisms 108 away from the pins 111 to allow relative pivoting of the upper mount frame 38 with respect to the lower mount frame 46. The latch release mechanism 113 of FIG. 5 may be manually operated by an occupant pressing a release button 115 to cause an electrical signal to run through wires 117 to actuators (not shown) within the latching mechanisms 108. The actuators move the latches of the latching mechanisms 108 away from the pins 111, as discussed above. The wires 117 extend through holes 109 in the upper mount frame 38. The latch release mechanism 115 may be a solenoid actuator that pulls on cables (i.e., the wires 112 are replaced by cables) when release button 115 is pressed to pull latches within the latching mechanism 108 to release the pins 111. Alternatively, the latch release mechanism 115 may be a lever and the wires may be replaced by cables that manually pull the latches within the latching mechanisms 108 when the lever is pulled. Both of these alternatives describe a manually operated latch release mechanism.

Referring to FIG. 1, in an automatic system, a sensor 119 may be operatively connected to the door 22 to send a sensor signal to a controller 121 indicating that the door is opened. The controller 121 then sends a control signal to the latch release mechanism 115 or to actuator of the latching mechanisms 108 (depending on the specific latching mechanism design) to cause the latches to release the pins 111. Preferably, the senor 119 may also be employed in either the automatic or manual system to override the ability of the latch release mechanism 113 to cause the latching mechanism 108 to release the pins 111 when the door 22 of FIG. 1 is closed. When the door 22 is closed, the sensor signal sent to the controller 121 causes the controller 121 to send a signal to the latch release mechanism 113 that prevents operation of the push button 115 from affecting the latching mechanisms 108.

In an automatic system, if the seat 24 is a power seat, an additional sensor may be positioned on the seat track assembly 48 to cause the controller 121 to reposition the seat 24 forward if the sensor indicates that the seat 24 is too far rearward to clear the B-pillar. This is especially helpful for tall occupants who may position the seat 24 far rearward. The controller 121 may be programmed to move the seat 24 forward or rearward at the same time that the seat 24 is rotating outward or inward, respectively. If a seat position memory system is offered as an option (i.e., the ability to set a seat position preference or preferences into the controller 121), the fore or aft movement of the seat from or to a preferred position in conjunction with rotating outward or inward, respectively, may be programmed into the memory of the controller 121.

Finally, a vehicle with the automatic latch release system described above may optionally be operated manually by providing a mode selection button 123 (shown on the console 40, but positioned anywhere convenient including on a key FOB) that, when pushed, sends a signal to the controller 121 to not generate an automatic control signal in response to the sensor 119 sensing that the door 22 is opened. A subsequent push of the mode selection button 123 will switch the system back to automatic mode. The mode selection button 123 may also be twistable to provide a speed control function. That is, the button may have a knob-like outer portion that is twistable to different predetermined positions correlated with different speeds of rotation of the seat 24 (e.g., different speed settings of the motor 277 described with respect to FIG. 7). The knob portion of the mode selection button 123 may be a detent having set positions at set rotational angles, with a first position at one rotational extreme being the slowest rotational speed and the position rotated furthest from the first position being the fastest rotational speed. Alternatively, the knob portion could be a rheostat control, with full counter-clockwise rotation setting the motor speed to a slowest speed and full clockwise rotation setting the motor speed to a fastest speed. Thus, a seat occupant could set the rotational speed of the seat 24 to allow ample time to move legs and feet over the rocker panel 16 and seal plate 18 of FIG. 1.

A warning light on the dash 42 may be provided in either an automatic of manual system to alert the driver whenever the latching mechanisms 108 are not latched. This may be accomplished by operatively connecting sensors on the latch mechanism 108 with the controller 121. When the mode selection button 123 is pushed to provide manual operation, the lower seat portion 30 can be pivoted only by manually pushing the latch release button 115 to release latch pins in the latch release mechanisms 108 and thereby allow manual pivoting of the lower seat portion 30 by the occupant (with assistance from one of the optional torsional springs 125, 127 described below, if present).

If the seat 24 is manually operated, an optional torsional spring may be used to assist pivoting of the lower seat portion 30. In FIG. 3, two torsional springs are used. An inner torsional spring 125 is nested in side of an outer torsional spring 127. Both the inner and outer torsional springs 125, 127 are wound concentrically about the pivot shaft 62 and seated in an annular recess 129 in the lower mount frame 46. Ends of both of the springs 125, 127 are secured to the upper mount frame 38. One of the torsional springs is wound to provide a counter clockwise biasing force and the other is wound to provide a clockwise biasing force. Thus, when the lower seat portion 30 pivots in one direction (from the first position to the second position), one spring unwinds or unloads its biasing force to assist in the pivoting, while the pivoting causes the other spring to wind or load. When the lower seat portion 30 is in the first position, the locking function of the latching mechanism 108 will hold the bias of the wound spring. A stopper may be provided to selectively lock the lower seat portion 30 in the second position to hold the biasing force of the other spring, which is wound in the second position.

With either the automatic or manually operated lower seat portion 30, a drive motor similar to those used in adjusting power vehicle seats may be used to cause power pivoting of the lower seat portion 30. Referring to FIG. 7, a pivot shaft 262 similar to that of FIG. 3 has an externally splined portion 271 that meshes with an internally splined gear 273 concentric about the shaft 262. The gear 273 has external gear teeth that intermesh with a threaded drive shaft 275 of an electric drive motor 277 (i.e., the drive shaft 275, shown in end view in FIG. 7, has a worm gear threading to intermesh with and drive gear 273 which in turn drives the pivot shaft 262 to pivot the lower seat portion 30). The drive motor 277 has a casing 279 mounted to a bottom surface of the lower mount frame 46 by bolts extending through openings (not shown) in the casing 279 and mating with threaded openings (not shown) in the lower mount frame 46. Preferably, a cover shield (not shown) extends from the lower mount frame 46 or from the seat track 48 to surround the drive motor 277, the drive shaft 275, and the gear 273. For the automatically operated lower seat portion 30, the controller 121 is operatively connected to the drive motor 277 to cause the drive motor 277 to turn the pivot shaft 262 in response to the sensor signal from sensor 119 indicating that the door 22 is opened (unless the manual override button 123 has been pushed, in which case the drive motor 277 will not operate in response to a sensor signal from a sensor 119, but instead the lower seat portion 30 may be manually pivoted by an occupant after the occupant depresses the manual latch release button 115

While the best modes for carrying out the invention have been described in detail, those familiar with the art to which this invention relates will recognize various alternative designs and embodiments for practicing the invention within the scope of the appended claims.

1. A vehicle seat comprising:
a seat back portion; and
a lower seat portion laterally pivotable independently of said seat back portion.

2. The vehicle seat of claim 1, wherein said lower seat portion is laterally pivotable about an axis running through said lower seat portion.

3. The vehicle seat of claim 2, further comprising:
a motor operatively connected with said lower seat portion to pivot said lower seat portion.

4. The vehicle seat of claim 2, further comprising:
a torsion spring concentric with said pivot axis and biased to urge lateral pivoting of said lower seat portion with respect to said seat back portion.

5. The vehicle seat of claim 1, wherein said lower seat portion is laterally pivotable at least 60 degrees.

6. The vehicle seat of claim 1, wherein said lower seat portion pivots about a pivot axis running through said lower seat portion; wherein said lower seat portion includes an upper mount frame, and further comprising:
a vehicle floor;
a seat track assembly attached to said vehicle floor; and
a lower mount frame nonpivotably attached to said seat track assembly;
wherein said upper mount frame is spaced axially from said lower mount frame and pivots laterally relative to said lower mount frame and said seat track assembly.

7. The vehicle seat of claim 6, further comprising:
a friction-reducing member attached to a surface of one of said lower mount frame and said upper mount frame and positioned between said upper and said lower mount frames; and wherein said friction-reducing member is characterized by a coefficient of friction less than a coefficient of friction of said mount frame to which said friction-reducing member is attached, said friction-reducing member thereby decreasing frictional resistance to lateral pivoting of said lower seat portion.

8. The vehicle seat of claim 6, wherein said upper mount frame and said lower mount frame are releasably lockable to one another.

9. The vehicle seat of claim 8, wherein one of said upper mount frame and said lower mount frame includes at least one latching mechanism; wherein the other of said upper mount frame and said lower mount frame includes at least one pin; and wherein said latching mechanism latches to said pin to lock said mount frames together when said lower seat portion is in a first position and selectively releases said pin to unlock said mount frames to permit lateral pivoting of said lower seat portion to a second position.

10. The vehicle seat of claim 9, further comprising:
a latch release mechanism operatively connected with said at least one latching mechanism and operable to cause said at least one latching mechanism to release said at least one pin.

11. The vehicle seat of claim 6, wherein one of said upper mount frame and said lower mount frame includes a guide slot; wherein the other of said upper mount frame and said lower mount frame includes an extension; wherein said extension extends through said guide slot and translates therein during lateral pivoting of said lower seat portion; and wherein lateral pivoting of said lower seat portion is limited by interference between an end of said guide slot and said extension.

12. The vehicle seat of claim 6, further comprising:
an annular bearing plate mounted between said lower mount frame and said upper mount frame; and
a center support member having an extension portion extending through an opening in said upper mount frame and a shoulder portion resting on said upper mount frame around said opening; wherein said extension portion further extends through an opening in said annular bearing plate and is attachable to said lower mount frame.

13. The vehicle seat of claim 6, further comprising:
a pivot shaft concentric with said pivot axis and rigidly secured to said upper mount frame; and wherein said pivot shaft extends through said lower mount frame.

14. A vehicle comprising:
a vehicle seat having a seat back portion and a lower seat portion;
a vehicle frame forming a door opening adjacent said vehicle seat; and
a console running fore and aft adjacent said vehicle seat opposite said door opening;
wherein said lower seat portion is laterally pivotable with respect to said door opening independently of said seat back portion without interfering with said console.

15. The vehicle of claim 14, wherein said lower seat portion laterally pivots to extend at least partially through said door opening while said seat back portion and said console remain stationary.

16. The vehicle of claim 14, wherein said lower seat portion pivots laterally about an axis that extends through said lower seat portion inside of an outer perimeter of said lower seat portion.

17. The vehicle of claim 14, wherein said lower seat portion laterally pivots between a first position in which a forward edge of said lower seat portion is inboard of and transverse with respect to said door opening and a second position in which said forward edge is substantially outboard of said door opening.

18. The vehicle of claim 14, further comprising:
a door supported by said vehicle frame and selectively openable and closeable with respect to said door opening;
a sensor operatively connected to said door and operable to sense opening of said door and send a sensor signal in response to opening of said door;
a controller in signal communication with said sensor and operable for receiving and processing said sensor signal and sending a control signal in response to said sensor signal; and
a motor in signal communication with said controller, operatively connected to said lower seat portion and selectively powerable in response to receipt of said control signal from said controller to cause lateral pivoting of said lower seat portion.

19. A vehicle comprising:
a vehicle seat having a seat back portion and a lower seat portion;
a vehicle frame forming a door opening adjacent said vehicle seat;
a console running fore and aft adjacent said vehicle seat opposite said door opening; wherein said lower seat portion is laterally pivotable with respect to said door opening independently of said seat back portion without interfering with said console;
a door supported by said vehicle frame and selectively openable and closeable with respect to said door opening;
a sensor operatively connected to said door and operable to sense opening of said door and send a sensor signal in response to opening of said door;
a controller in signal communication with said sensor and operable for receiving and processing said sensor signal and sending a control signal in response to said sensor signal; and
a latching mechanism in signal communication with said controller and operable for receiving said control signal and selectively latching and releasing said lower seat portion; wherein said latching mechanism releases said lower seat portion in response to receipt of said control signal from said controller.
